(19) United States
(12) Patent Application Publication
(10) Pub. No.: US 2013/0128971 A1
(43) Pub. Date: May 23, 2013

(54) TRANSFORMS IN VIDEO CODING

(71) Applicant: Qualcomm Incorporated, San Diego, CA (US)

(72) Inventors: Liwei Guo, San Diego, CA (US); Xianglin Wang, San Diego, CA (US); Marta Karczewicz, San Diego, CA (US)

(73) Assignee: Qualcomm Incorporated, San Diego, CA (US)

(21) Appl. No.: 13/682,153

(22) Filed: Nov. 20, 2012

Related U.S. Application Data
(60) Provisional application No. 61/563,414, filed on Nov. 23, 2011.

(51) Int. Cl. H04N 7/26

(52) U.S. Cl. CPC H04N 19/00781
USPC 375/240.12; 375/240.18

(57) ABSTRACT

Aspects of this disclosure relate to coding video data. In an example, a method of coding video data includes determining a first residual quadtree (RQT) depth at which to apply one or more first transforms to residual video data based on at least one characteristic of the residual of video data. The method also includes determining a second RQT depth at which to apply one or more second transforms to the residual video data based on the at least one characteristic. The method also includes coding the residual video data using the one or more first transforms and the one or more second transforms.

This application claims the benefit of U.S. Provisional Application No. 61/563,414, filed Nov. 23, 2011, which is incorporated herein by reference in its entirety.

### TECHNICAL FIELD

This disclosure relates to video coding and, more particularly, to the use of transforms in video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

The techniques of this disclosure generally relate to applying transforms in video coding. For example, during video coding, a video coder may divide a block of video data according to a hierarchical quadtree partitioning structure. In addition, for each block, the video coder may calculate residual values corresponding to pixel differences between pixels of the unencoded picture and predicted pixel values. The video coder may then apply a transform (e.g., a discrete cosine transform (DCT), an integer transform, a wavelet transform, or a conceptually similar transform) to the residual video data to produce residual transform coefficients.

The techniques of this disclosure relate to applying different sizes of transforms to video data based on a characteristic of the video data. For example, according to aspects of this disclosure, a video coder may apply different transform partitioning limitations to a given portion of video data based on a characteristic of the video data being coded. That is, the video coder may implement more than one maximum RQT depth (e.g., representing the number of times a block of video data has been divided) based on a characteristic of the video data being coded.

In an example, aspects of this disclosure relate to a method of coding video data that includes determining a first residual quadtree (RQT) depth at which to apply one or more first transforms to residual video data based on at least one characteristic of the residual of video data, determining a second RQT depth at which to apply one or more second transforms to the residual video data based on the at least one characteristic, and coding the residual video data using the one or more first transforms and the one or more second transforms.

In another example, aspects of this disclosure relate to an apparatus for coding video data that includes one or more processors configured to determine a first residual quadtree (RQT) depth at which to apply one or more first transforms to residual video data based on at least one characteristic of the residual of video data, determine a second RQT depth at which to apply one or more second transforms to the residual video data based on the at least one characteristic, and code the residual video data using the one or more first transforms and the one or more second transforms.

In another example, aspects of this disclosure relate to an apparatus for coding video data that includes means for determining a first residual quadtree (RQT) depth at which to apply one or more first transforms to residual video data based on at least one characteristic of the residual of video data, means for determining a second RQT depth at which to apply one or more second transforms to the residual video data based on the at least one characteristic, and means for coding the residual video data using the one or more first transforms and the one or more second transforms.

In another example, aspects of this disclosure relate to a non-transitory computer-readable medium storing instructions that, when executed, cause one or more processors to determine a first residual quadtree (RQT) depth at which to apply one or more first transforms to residual video data based on at least one characteristic of the residual of video data, determine a second RQT depth at which to apply one or more second transforms to the residual video data based on the at least one characteristic, and code the residual video data using the one or more first transforms and the one or more second transforms.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIG. 4 illustrates an example block of video data including luma and chroma samples associated with the block of video data.

FIG. 5 illustrates example prediction unit types for predicting video data.

FIG. 6A illustrates an example hierarchical quadtree structure, according to aspects of this disclosure.

FIG. 6B illustrates an example division of a transform unit according to the hierarchical quadtree structure shown in FIG. 6A.

FIG. 7 is a flow diagram illustrating an example method of applying transforms based on a characteristic of the video data being coded, according to aspects of this disclosure.

FIG. 8 is a flow diagram illustrating an example method of encoding transform information, according to aspects of this disclosure.

FIG. 9 is a flow diagram illustrating an example method of decoding transform information, according to aspects of this disclosure.

### DETAILED DESCRIPTION

The JCT-VC is working on development of the HEVC standard. The HEVC standardization efforts are based on an evolving model of a video coding device referred to as the HEVC Test Model (HM). In general, according to the proposed HEVC standard, a video frame or picture may be divided into a sequence of treeblocks or largest coding units (LCU) that include both luma and chroma samples. For example, a treeblock generally includes an N×N block of luma samples (Y) together with the two corresponding blocks of chroma samples (Cb, Cr) for a picture that has three sample arrays. In some examples, chroma information may be sub-sampled with respect to luma information. That is, for a given block of video data, a luma component may be sampled at twice the rate of a chroma component.

Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. For example, a treeblock, as a root node (e.g., LCU) of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split (e.g., which may be referred to as a maximum CU depth), and may also define a minimum size of the coding nodes.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU).

A CU includes a coding node and prediction units (PUs) and transform units (TUs) associated with the coding node, as described in greater detail below. A size of the CU corresponds to a size of the coding node and is generally square in shape. The size of the CU may range from 8×8 pixels up to the size of the treeblock with a maximum of 64×64 pixels or greater. Each CU may contain one or more TUs and one or more PUs.

Syntax data associated with a CU may describe the partitioning of a CU into one or more TUs. In general, TUs define the manner in which transforms are applied to luma and chroma samples. That is, for example, pixel difference values associated with the TUs may be transformed to produce transform coefficients, which may be quantized.

As noted above, syntax data associated with a CU may also describe, for example, partitioning of a leaf CU into one or more PUs. Partitioning modes may differ between whether the CU is skip or direct mode encoded, intra-prediction mode encoded, or inter-prediction mode encoded. In general, a PU represents a spatial area corresponding to all or a portion of the corresponding CU, and may include data for retrieving a reference sample for the PU. Moreover, a PU may include data related to prediction. For example, when the PU is intra-mode encoded, the PU may include data describing an intra-prediction mode for the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In some instances, a PU for a given area may be divided into more than one section, and each section may be predicted in a different manner. For example, as described in this disclosure, a PU type generally refers to a division of prediction data for a given portion of video data. Accordingly, in some examples a PU type may refer to a size of a PU used to predict video data, which may be defined according to a partitioning mode. In an example, assuming that the size of a particular CU is 2N×2N, video data may be predicted in PU types of 2N×2N, N×N, 2N×N, or N×2N. In some instances, PUs may also be asymmetrically partitioned in PU types of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom. In other examples, PU type may refer to a prediction mode (e.g., a mode associated with inter- or intra-prediction) or a prediction direction associated with a PU.

In some examples, residual samples corresponding to a CU may be subdivided into smaller units using a quadtree structure known as “residual quad tree” (RQT). The RQT may apply to both luma and chroma components of the CU. In general, an RQT is a recursive representation of the partitioning of a CU into TUs. For example, a split flag may indicate whether a leaf-CU is split into four transform units. Then, each transform unit may be split further into four sub-TUs. When a TU is not split further, it may be referred to as a leaf-TU.

Accordingly, a leaf-CU may include the RQT indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

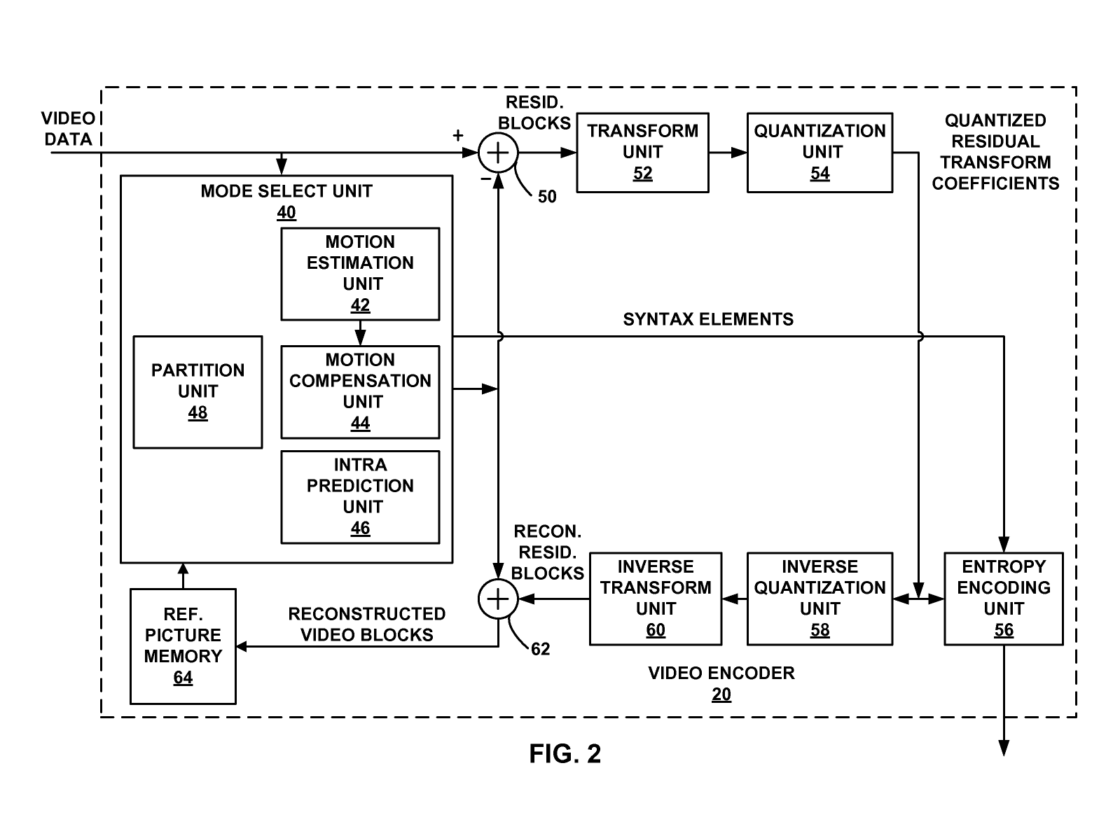

In general, coding efficiency may be improved by avoiding large variations in residual values associated with a given TU. That is, applying a transform to generally uniform residual values may result in concentrating energy in a relatively small number of transform coefficients. As described in greater detail below with respect to FIG. 2, in general, concentrating energy in a relative small number of transform coefficients may improve entropy coding efficiency. In some instances, the number of times a TU is divided (e.g., divided according to an RQT structure) may be determined based on a rate-distortion analysis (e.g., rate-distortion optimization). However, the number of times a TU may be divided may be limited according to a transform partitioning limitation, as described below.

Luma samples of a given frame (or slice) may typically be subject to wider and/or more dramatic variation than chroma samples. Chroma samples, on the other hand, may be relatively uniform for a given block. Accordingly, while a relatively small TU size may be needed to avoid large luma residual variations, larger TUs may be used for transforming chroma residuals without impacting coding efficiency.

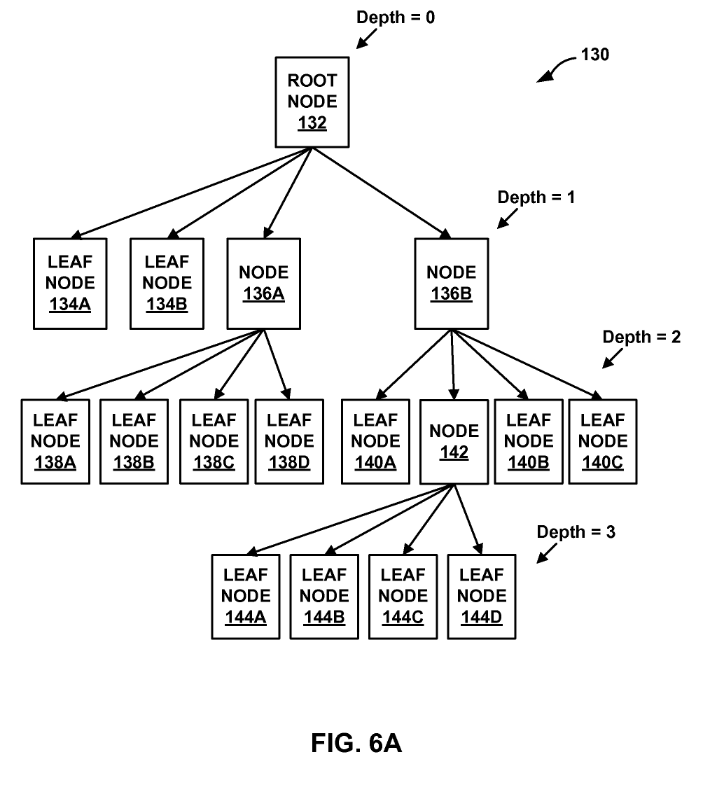

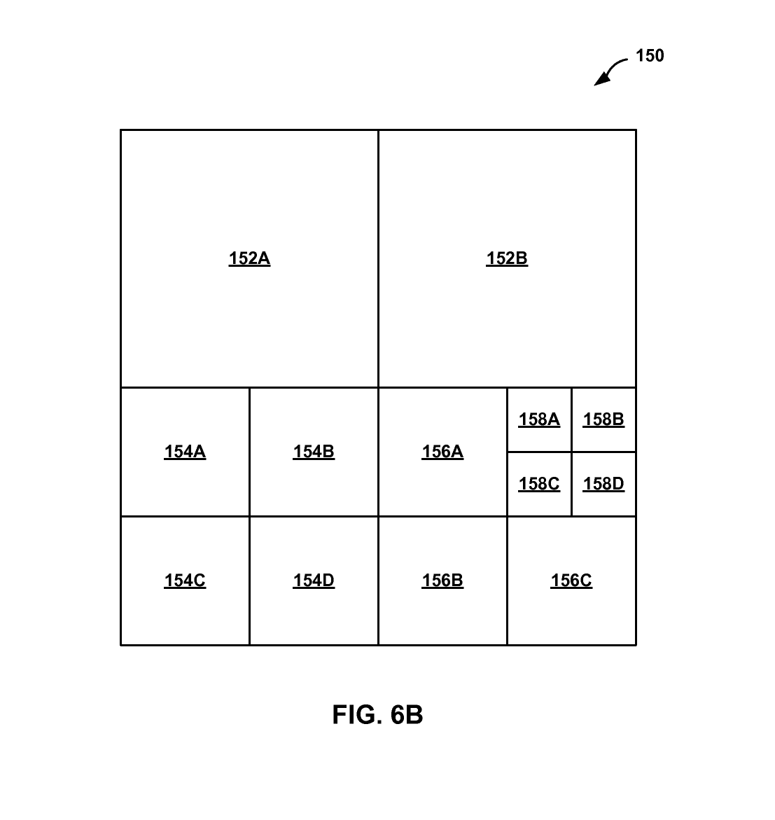

Typically, a video coder applies the same transform partitioning limitations to both the luma and chroma samples of video data, and does not consider PU type when determining transform partitioning limitations. That is, as described in this disclosure, a transform partitioning limitation may generally refer to a limit on the number of times a block of residual video data may be divided when applying transforms. In some instances, a transform partitioning limitation may be described with respect to an RQT structure. For example, a transform partitioning limitation may refer to the number of times a TU may be divided according to an RQT structure. That is, a maximum RQT depth (or maximum RQT level) may refer to the maximum number of times a TU may be divided, where “deeper” corresponds to a lower position in the RQT and a generally smaller TU (as shown, for example, in FIGS. 6A and 6B).

In an example for purposes of illustration, a maximum RQT depth of one indicates that a video coder may divide a TU one time when applying transforms, while a maximum RQT depth of two indicates that the video coder may divide at least a portion of the TU two times when applying transforms. Maximum RQT depth may also be referred to as maximum allowable RQT depth, indicating that a video coder may partition a TU up to the maximum RQT depth, but may partition the TU less than the maximum RQT depth. In other examples, a transform partitioning limitation may also include a specific RQT depth for partitioning a TU. For example, a video encoder may signal a specific RQT depth to which a TU must be partitioned. Upon receiving such signaling, the video decoder partitions the TU according to the received RQT depth indication.

The techniques of this disclosure relate to applying different sizes of transforms to video data based on a characteristic of the video data. For example, according to aspects of this disclosure, a video coder may apply different transform partitioning limitations to a given portion of video data based on a characteristic of the video data being coded. That is, the video coder may implement more than one maximum RQT depth based on a characteristic of the video data being coded.

In an example for purposes of illustration, according to aspects of this disclosure, a video coder may implement more than one maximum RQT depth based on a colorspace of the video data being coded. That is, the video coder may use a different maximum RQT depth for applying transforms to luma samples of a given portion of video data (e.g., a block, slice, frame, sequence of frames, or the like) than for chroma samples of the video data. To illustrate with an example, the video coder may apply a maximum RQT depth of three when applying transforms to residual luma samples and a maximum RQT depth of two when applying transforms to residual chroma samples. In this way, the video coder may use relatively smaller transforms for transforming residual luma samples, while also maintaining larger transforms for transforming residual chroma samples.

Such an approach may increase coding efficiency. For example, as noted above, applying a transform to generally uniform residual values may result in concentrating energy in a relatively small number of transform coefficients, which typically improves entropy coding efficiency. Accordingly, applying relatively small transforms may increase coding efficiency, as there may be a higher likelihood of uniform residual values in a relatively small area. However, needlessly applying many small transforms may be less computationally efficient than applying single, relatively larger transform. The techniques of this disclosure provide a way in which to manage the size of transforms being applied to video data based on a characteristic of the video data in order to maximize coding efficiency. For example, aspects of this disclosure relate to allowing smaller transforms to be used in areas that may benefit from smaller transforms, while also preventing smaller transforms from being used in areas in which there is a lower likelihood that smaller sized transforms are needed.

The example above is described with respect to a colorspace characteristic. In another example, according to aspects of this disclosure, a video coder may implement more than one maximum RQT depth based on a PU type of the video data being coded. For example, a PU that is divided into more than one section for prediction purposes may be more likely to be associated with varying pixel values (and associated residual values). That is, the PU type (e.g., 2N×2N, N×N, and the like) may be determined according to a rate-distortion analysis. Varying pixel values may require a CU to be divided into sections for purposes of prediction to produce acceptable residual values according to the rate-distortion analysis.

Accordingly, the techniques of this disclosure may be implemented to provide a first maximum RQT depth for a first type of PU (e.g., a divided PU) and a second maximum RQT depth for another type of PU (e.g., an undivided PU). In an example for purposes of illustration, a video coder may apply a maximum RQT depth of three when applying transforms to video data associated with N×N PUs and a maximum RQT depth of two when applying transforms to video data associated with 2N×2N PUs. Other variations are also possible, as described in greater detail below.

In some instances, according to aspects of this disclosure, one or more indications of a maximum allowable RQT depth may be provided in a coded bitstream. For example, a video encoder may encode (and a video decoder may parse from an encoded bitstream) high level syntax elements that indicate one or more maximum allowable RQT depths at the sequence level, a group of pictures level, a picture level, a slice level, or for one or more CUs. In an example, for purposes of illustration, syntax elements may indicate a maximum RQT depth for luma samples (e.g., max_luma_RQT_level) and a maximum RQT depth for chroma samples (e.g., max_chroma_RQT_level). In another example, syntax elements may include a max_luma_RQT_level element and a max luma_chroma_RQT_level_delta element, where the max luma_chroma_RQT_level_delta specifies the difference between the maximum RQT depth for luma samples and chroma samples.

In yet another example, syntax elements may indicate one or more maximum RQT depths for different PU types. For example, syntax elements may include a max_RQT_level_{—}2N×2N element, a max_RQT_level_{—}2N×N element, a max_RQT_level_N×2N element, and the like to indicate the maximum RQT depths for the different types of PUs. Additional examples of syntax elements associated with PU types are provided below with respect to FIGS. 6A and 6B.

In this way, transforms may be applied at different granularities depending on the video data being coded. Applying transforms at different granularities may increase coding efficiency, as described above. For example, aspects of this disclosure relate to allowing smaller transforms to be used in areas that may benefit from smaller transforms, while also preventing smaller transforms from being used in areas in which there is a lower likelihood that smaller sized transforms are needed.

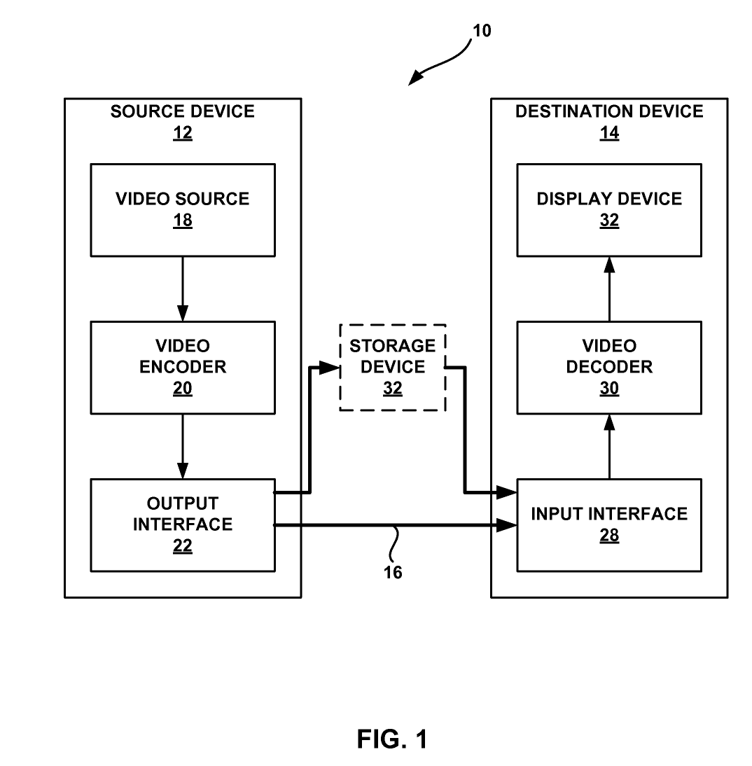

FIG. 1 is a block diagram illustrating an example video encoding and decoding system 10 that may utilize the techniques described in this disclosure for applying a transforms in video coding. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads or tablets, televisions, cameras, display devices, digital media players, video gaming consoles, video streaming or playback devices, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 32. Similarly, encoded data may be accessed from storage device 32 by input interface 28. Storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 32 may correspond to a file server or another intermediate storage device that may hold the encoded video generated by source device 12. Destination device 14 may access stored video data from storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 32 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 12. The encoded video data may be transmitted directly to destination device 14 via output interface 22 of source device 20. The encoded video data may also (or alternatively) be stored onto storage device 32 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 32, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder or decoder circuitry, as applicable, including a processor such as one or more microprocessors, digital signal processors (DSPs), special purpose processors or processing circuits, application specific integrated circuits (ASICs), field programmable gate arrays (FPGAs), fixed logic circuitry, discrete logic, software, hardware, firmware or any combinations thereof. Accordingly, the various units within video encoder 20 and video decoder 30 likewise may be implemented by any of a variety of such structural elements or combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to storage device 32) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

As noted above, the JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example and as noted above, the HM supports prediction in various PU sizes (also referred to as PU types). Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom. Other partitioning types are also possible.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded, original picture and prediction values corresponding to the PUs. Video encoder 20 may form the TUs including the residual data for the CU, and then transform the TUs to produce transform coefficients for the CU.

In some examples, as noted above, TUs may be defined according to an RQT. For example, an RQT may represent the manner in which transforms (e.g., DCT, integer transform, wavelet transform, or one or more other transforms) are applied to the residual luma samples and the residual chroma samples associated with a block of video data. That is, as noted above, residual samples corresponding to a CU may be subdivided into smaller units using an RQT. In general, the RQT is a recursive representation of the partitioning of a CU into TUs.

Typically, video encoder 20 applies the same transform partitioning limitations to both the luma and chroma samples of video data, and does not consider PU type when determining transform partitioning limitations. For example, video encoder 20 may establish a single maximum RQT depth of limiting the number of times a TU can be partitioned according to an RQT structure. The maximum RQT depth may apply to all video data for a given portion of video data (e.g., a block, slice, frame, sequence of frames, or the like).

The techniques of this disclosure relate to applying different sizes of transforms to video data based on a characteristic of the video data. For example, according to aspects of this disclosure, video encoder 20 may apply different transform partitioning limitations to a given portion of video data based on a characteristic of the video data being coded. That is, video coder 20 may implement more than one maximum RQT depth based on a characteristic of the video data being coded.

In some examples, according to aspects of this disclosure, video encoder 20 may implement more than one maximum RQT depth based on a colorspace of the video data being coded. That is, for example, video encoder 20 may use a different maximum RQT depth for applying transforms to luma samples than for chroma samples. In other examples, video encoder 20 may implement more than one maximum RQT depth based on a PU type of the video data being coded.

In addition, according to aspects of this disclosure, video encoder 20 may encode one or more indications of a maximum allowable RQT depth in a bitstream. For example, video encoder 20 may signal one or more syntax elements that indicate one or more maximum allowable RQT depths at the sequence level, a group of pictures level, a picture level, a slice level, or for one or more CUs. For example, syntax elements may indicate a maximum RQT depth for luma samples and a maximum RQT depth for chroma samples. In another example, syntax elements may indicate one or more maximum RQT depths for different PU types.

While described with respect to maximum RQT depths, it should be understood that in other examples, video encoder 20 may implement the techniques of this disclosure by specifying an RQT depth to which a TU must be partitioned. For example, video encoder 20 may use a different RQT depth for applying transforms to luma samples than for chroma samples. In other examples, video encoder 20 may implement more than one RQT depth based on a PU type of the video data being coded. Video encoder 20 may specify the RQT depths using syntax elements, as described above with respect to maximum RQT depths.

In this way, video encoder 20 may apply transforms at different granularities depending on the video data being coded. Applying transforms at different granularities may increase coding efficiency, as described above. For example, video encoder 20 may use smaller transforms in areas that may benefit from smaller transforms, while also avoiding the use of smaller transforms in areas in which there is a lower likelihood that smaller sized transforms are needed.

Following application of any transforms to residual data to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data. A current version of HEVC is designed to use CABAC for entropy coding.

Video decoder 30, upon receiving the coded video data, may perform a decoding pass generally reciprocal to the encoding pass described with respect to video encoder 20. According to aspects of this disclosure, for example, video decoder 30 may receive coded video data and determine a transform partitioning limitation for applying an inverse transform to the received video data. Video decoder 30 may apply different transform partitioning limitations to a given portion of video data based on a characteristic of the video data being decoded. That is, video decoder 30 may implement more than one maximum RQT depth (or specific RQT depth) based on a characteristic of the video data being coded, as described with respect to video encoder 20 above.

According to some aspects of this disclosure, video decoder 30 may parse and decode one or more indications of a transform partitioning limitation. For example, video decoder 30 may decode an indication a maximum allowable RQT depth from an encoded bitstream. That is, video decoder 30 may decode one or more syntax elements that indicate one or more maximum allowable RQT depths that are signaled at the sequence level, a group of pictures level, a picture level, a slice level, or for one or more CUs.

FIG. 2 is a block diagram illustrating an example video encoder 20 that may implement the techniques described in this disclosure for applying a transforms in video coding. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

As shown in FIG. 2, video encoder 20 receives video data to be encoded. In the example of FIG. 2, video encoder 20 includes a mode select unit 40, summer 50, transform unit 52, quantization unit 54, entropy encoding unit 56, and reference picture memory 64. Mode select unit 40, in turn, includes motion estimation unit 42, motion compensation unit 44, intra prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional loop filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal compression. Intra-prediction unit 46 may alternatively perform intra-predictive coding of the received video block relative to one or more neighboring blocks in the same frame or slice as the block to be coded to provide spatial compression. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, also referred to as residual data, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain.

According to aspects of this disclosure, transform processing unit 52 may apply different sizes of transforms to video data based on a characteristic of the video data. For example, according to aspects of this disclosure, transform processing unit 52 may apply different transform partitioning limitations to a given portion of video data based on a characteristic of the video data being coded. That is, transform processing unit 52 may implement more than one maximum RQT depth based on a characteristic of the video data being coded.

In some examples, according to aspects of this disclosure, transform processing unit 52 may implement more than one maximum RQT depth based on a colorspace of the video data being coded. That is, for example, transform processing unit 52 may use a different maximum RQT depth for applying transforms to luma samples than for chroma samples. In other examples, transform processing unit 52 may implement more than one maximum RQT depth based on a PU type of the video data being coded. Other examples are also possible. For example, transform processing unit 52 may implement one or more maximum RQT depths based on block size, prediction direction, prediction type (e.g., intra-prediction or inter-prediction), motion vector amplitude, reference frame index, and the like.

While described with respect to maximum RQT depths, it should be understood that in other examples, transform processing unit 52 may implement the techniques of this disclosure by specifying an RQT depth to which a TU must be partitioned. For example, transform processing unit 52 may use a different RQT depth for applying transforms to luma samples than for chroma samples. In other examples, transform processing unit 52 may implement more than one RQT depth based on a PU type of the video data being coded.

In addition, according to aspects of this disclosure, transform processing unit 52 may signal one or more indications of a maximum allowable RQT depth (or specific RQT depth) in a bitstream. For example, transform processing unit 52 may signal one or more syntax elements that indicate one or more maximum allowable RQT depths at the sequence level, a group of pictures level, a picture level, a slice level, or for one or more CUs. For example, syntax elements may indicate a maximum RQT depth for luma samples and a maximum RQT depth for chroma samples. In another example, syntax elements may indicate one or more maximum RQT depths for different PU types. While described as being carried out by transform processing unit 52, it should be understood that such signaling may be carried out by another component of video encoder 20, such as entropy encoding unit 56 described below.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform CAVLC, CABAC, SBAC, PIPE, or another entropy coding technique. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

In this manner, video encoder 20 is an example of a video encoder that may perform a method including determining a first residual quadtree (RQT) depth at which to apply one or more first transforms to residual video data based on at least one characteristic of the residual of video data. The method also includes determining a second RQT depth at which to apply one or more second transforms to the residual video data based on the at least one characteristic. The method also includes coding the residual video data using the one or more first transforms and the one or more second transforms.

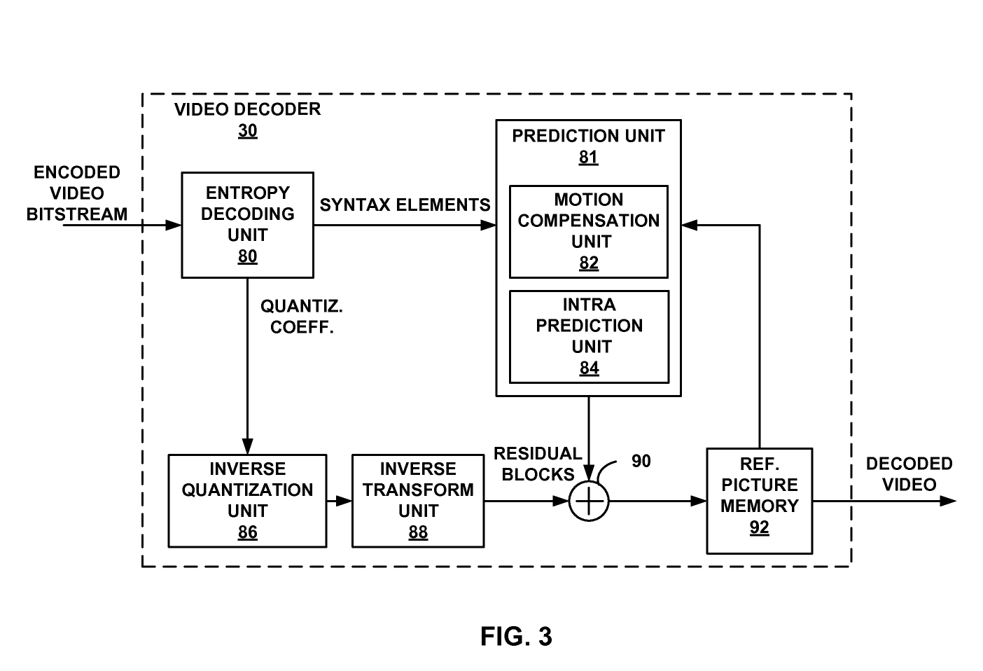

FIG. 3 is a block diagram illustrating an example video decoder 30 that may implement the techniques described in this disclosure for applying transforms in video coding. In the example of FIG. 3, video decoder 30 includes an entropy decoding unit 80, prediction unit 81, inverse quantization unit 86, inverse transformation unit 88, summer 90, and reference picture memory 92. Prediction unit 81 includes motion compensation unit 82 and intra prediction unit 84.

During the decoding process, video decoder 30 receives an encoded video bitstream that represents video blocks of an encoded video slice and associated syntax elements from video encoder 20. Entropy decoding unit 80 of video decoder 30 entropy decodes the bitstream to generate quantized coefficients, motion vectors, and other syntax elements. Entropy decoding unit 80 forwards the motion vectors and other syntax elements to prediction unit 81. Video decoder 30 may receive the syntax elements at the video slice level and/or the video block level.

For example, by way of background, video decoder 30 may receive compressed video data that has been compressed for transmission via a network into so-called “network abstraction layer units” or NAL units. Each NAL unit may include a header that identifies a type of data stored to the NAL unit. There are two types of data that are commonly stored to NAL units. The first type of data stored to a NAL unit is video coding layer (VCL) data, which includes the compressed video data. The second type of data stored to a NAL unit is referred to as non-VCL data, which includes additional information such as parameter sets that define header data common to a large number of NAL units and supplemental enhancement information (SEI). For example, parameter sets may contain the sequence-level header information (e.g., in sequence parameter sets (SPS)) and the infrequently changing picture-level header information (e.g., in picture parameter sets (PPS)). The infrequently changing information contained in the parameter sets does not need to be repeated for each sequence or picture, thereby improving coding efficiency. In addition, the use of parameter sets enables out-of-band transmission of header information, thereby avoiding the need of redundant transmissions for error resilience.

When the video slice is coded as an intra-coded (I) slice, intra prediction unit 84 of prediction unit 81 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 82 of prediction unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in reference picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied.

Inverse transform unit 88 applies an inverse transform, e.g., an inverse DCT, an inverse integer transform, or a conceptually similar inverse transform process, to the transform coefficients in order to produce residual blocks in the pixel domain. According to the aspects of this disclosure, inverse transform unit 88 may determine the manner in which transforms were applied to residual data. That is, for example, inverse transform unit 88 may determine an RQT that represents the manner in which transforms (e.g., DCT, integer transform, wavelet transform, or one or more other transforms) were applied to the residual luma samples and the residual chroma samples associated with a block of received video data.

According to aspects of this disclosure, inverse transform unit 88 may apply different transform partitioning limitations to a given portion of video data based on a characteristic of the video data being coded. For example, inverse transform unit 88 may determine a maximum RQT depth for applying inverse transforms to the video data based on a colorspace of the data, a PU type, or other characteristic of the data. In some instances, inverse transform unit 88 may implement more than one maximum RQT depth based on a characteristic of the video data being coded. In other instances, as noted above, inverse transform unit 88 may implement more than one specific RQT depth based on a characteristic of the video data being coded.

In any event, according to aspects of this disclosure, video decoder 30 may parse and decode one or more indications of a maximum allowable RQT depth (or specific RQT depth) from an encoded bitstream. For example, video decoder 30 may decode one or more syntax elements that indicate one or more maximum allowable RQT depths that are signaled at the sequence level, a group of pictures level, a picture level, a slice level, or for one or more CUs.

After motion compensation unit 82 generates the predictive block for the current video block based on the motion vectors and other syntax elements, video decoder 30 forms a decoded video block by summing the residual blocks from inverse transform unit 88 with the corresponding predictive blocks generated by motion compensation unit 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference picture memory 92 also stores decoded video for later presentation on a display device, such as display device 32 of FIG. 1.

In this manner, video decoder 30 is an example of a video decoder that may perform a method including determining a first residual quadtree (RQT) depth at which to apply one or more first transforms to residual video data based on at least one characteristic of the residual of video data. The method also includes determining a second RQT depth at which to apply one or more second transforms to the residual video data based on the at least one characteristic. The method also includes coding the residual video data using the one or more first transforms and the one or more second transforms.

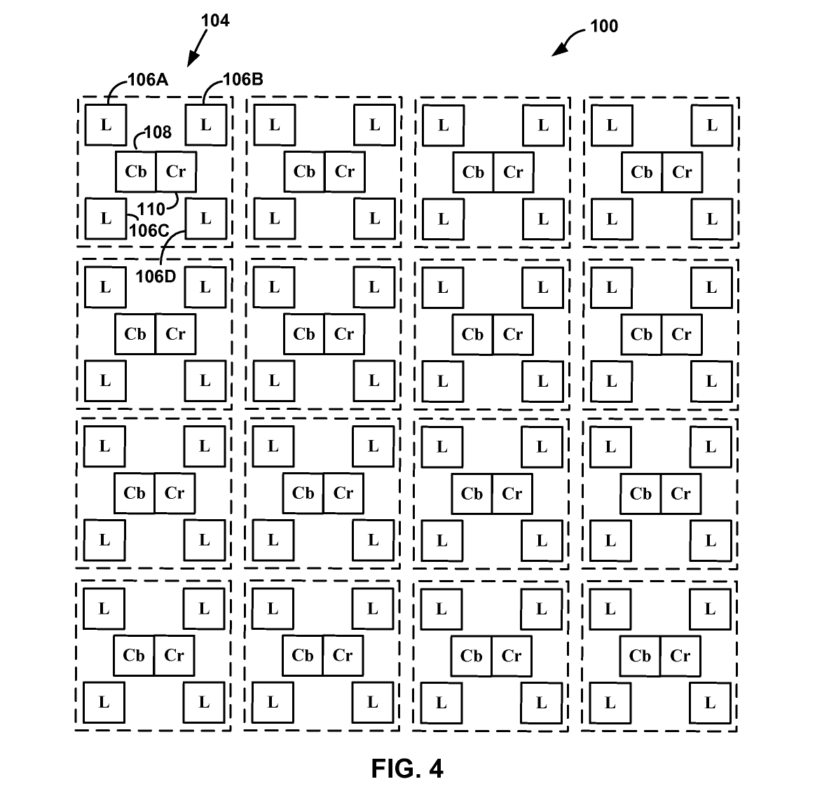

FIG. 4 illustrates an example block 100 of video data including luma samples 106A-D (luma samples 106) and chroma samples 108 (Cb) and 110 (Cr). The example shown in FIG. 4 generally illustrates nominal vertical and horizontal locations luma samples 106 and chroma samples 108, 110 that have been sampled according to a 4:2:0 sampling scheme. For example, as shown in FIG. 4, luma samples 106 are sampled at twice the rate of chroma samples 108, 110 in both the horizontal and vertical directions, with the chroma samples 108, 110 being sampled at the same rate.

The example shown in FIG. 4 is only one possible sampling scheme provided for purposes of explanation. That is, in other examples, different formats may specify different horizontal and vertical sampling rate ratios between the luma component and the chroma component. For example, for a block of video data with 4:2:2 format, the width of the luma component may be twice that of the chroma component. However, the height of the luma component may be the same as that for the chroma component. For a block of video data with a 4:4:4 format, the luma component and the chroma may be sampled at the same rates. The syntax for the luma and chroma arrays may be ordered such when data for all three color components is present, the data for the luma array is first, followed by data for the Cb array, followed by data for the Cr array, unless otherwise specified.

The example shown in FIG. 4 illustrates the luma component being sampled at a higher rate than the chroma components. In some instances, luma may be sampled at a higher rate than chroma, because the human eye is typically more sensitive to variations in luma than in chroma. Moreover, in general, luma samples may be subject to a wider and more dramatic variation within a given frame than chroma samples.

Typically, a video coder (such as video encoder 20 or video decoder 30) applies the same transform partitioning limitations to both the luma and chroma samples of video data. According to aspects of this disclosure, the video coder may apply different transform partitioning limitations to a given portion of video data based on whether the data includes luma samples or chroma samples. To illustrate with an example, the video coder may apply a maximum RQT depth of three when applying transforms to residual luma samples and a maximum RQT depth of two when applying transforms to residual chroma samples. In this way, the video coder may use relatively smaller transforms for transforming residual luma samples, while also maintaining larger transforms for transforming residual chroma samples.

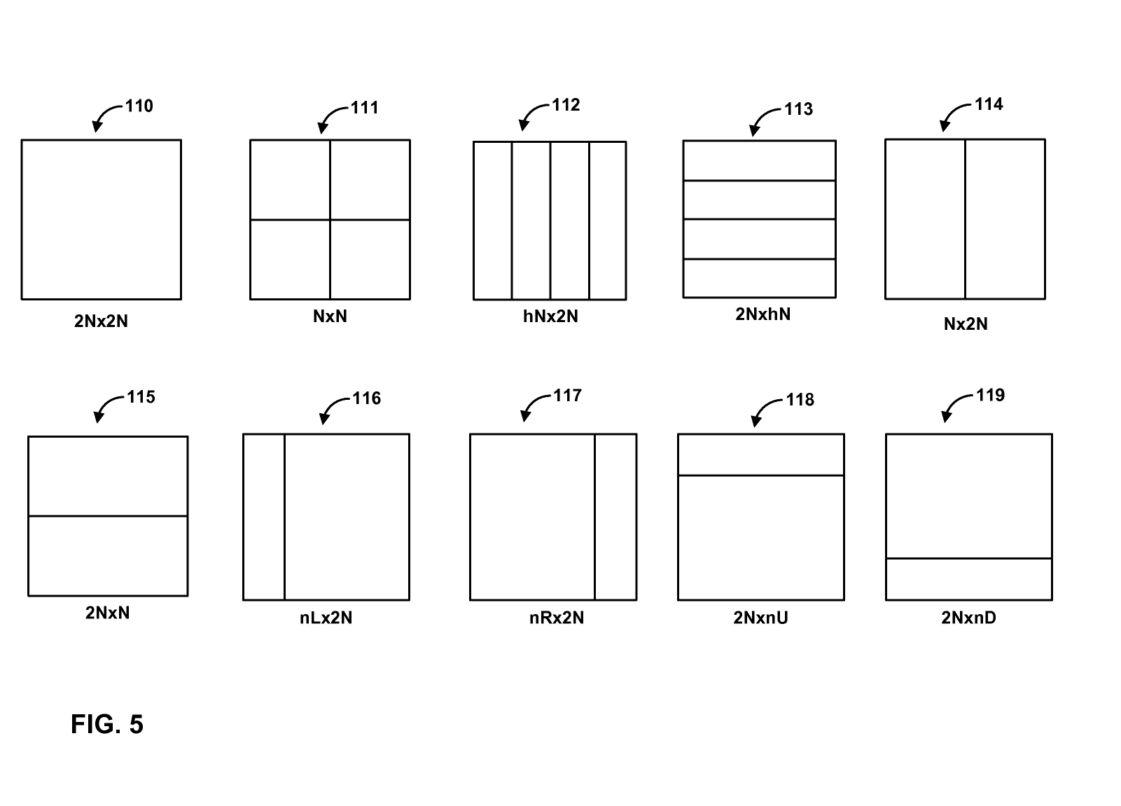

FIG. 5 generally illustrates partitioning modes (which may define PU sizes) that may be associated with prediction units. For example, assuming the size of a particular CU is 2N×2N, the CU may be predicted using PU types 2N×2N (110), N×N (111), hN×2N (112), 2N×hN (113), N×2N (114), 2N×N (115), nL×2N (116), nR×2N (117), 2N×nU (118), and 2N×nD (119). The PU types shown in the example of FIG. 5 are presented for purposes of illustration only, and other PU types may be used to indicate the manner in which video data is predicted. For example, as noted above, PU type may generally refer to a division of prediction data for a given portion of video data. Accordingly, in some examples a PU type may refer to a size of a PU used to predict video data, which may be defined according to a partitioning mode. In other examples, PU type may refer to a prediction mode (e.g., a mode associated with inter- or intra-prediction) or a prediction direction associated with a PU.

In some instances, a video coder (e.g., such as video encoder 20 and/or video decoder 30) may perform intra-prediction or inter-prediction using PU types 110 and 111. For example, the video coder may predict a CU as a whole using the 2N×2N PU 110 (single prediction technique). In another example, the video coder may predict the CU using four N×N sized PUs (PU type 111), with each of the four sections having a potentially different prediction technique being applied.

In addition, with respect to intra-coding, the video coder may perform a technique referred to as short distance intra-prediction (SDIP). If SDIP is available, the CU may be predicted using parallel PUs (PU types 112 and 113). That is, SDIP generally allows a CU to be divided into parallel PUs. Moreover, portions of the CU corresponding to the PUs may be predicted from portions of the same CU. For example, an 8×8 CU may be divided into four 8×2 PUs, where “N×M” refers to N pixels vertically and M pixels horizontally, in this example. The first PU may be predicted from neighboring pixels to the CU, the second PU may be predicted from neighboring pixels including pixels of the first PU, the third PU may be predicted from neighboring pixels including pixels of the second PU, and the fourth PU may be predicted from neighboring pixels including pixels of the third PU. In this manner, rather than predicting all pixels of the CU from pixels of neighboring, previously coded blocks to the CU, pixels within the CU may be used to predict other pixels within the same CU, using SDIP.

In the example, shown in FIG. 5, a CU may be predicted with four SDIP PUs in a hN×2N arrangement (PU type 112) where “h” represents one-half. In another example, a CU may be predicted with four SDIP PUs in an 2N×hN arrangement (PU type 113). The partitioning of the CU into SDIP PUs may be referred to as implementing SDIP partition modes. In other examples, additional prediction types may also be possible.

With respect to inter-coding, in addition to the symmetric PU types 110 and 111, the video coder may implement a side-by-side arrangement of PUs (PU types 114 and 115), or a variety of AMP (asymmetric motion partition) modes. With respect to the AMP modes, the video coder may asymmetrically partition a CU using PU types nL×2N (116), nR×2N (117), 2N×nU (118), and 2N×nD (119). In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.”

According to aspects of this disclosure, a video coder may implement one or more transform partitioning limitations based on the type of PU used to generate the residual value for a block of video data. For example, the video coder may determine a separate maximum RQT depth (or RQT depth) based on a PU type of the video data being coded, including any of the PU types shown in the example of FIG. 5.

For example, the video coder may use a first maximum RQT depth for transforming residual video data generated using PU type 110, a second maximum RQT depth for transforming residual video data generated using PU type 111, a third maximum RQT depth for transforming residual video data generated using PU 112, and so on. In some examples, a maximum RQT depth may be established for a group of PU types. That is, residual video data generated using certain PU types may share a maximum RQT depth, as described in greater detail below with respect to FIGS. 6A and 6B.

FIGS. 6A and 6B are conceptual diagrams illustrating an example residual quadtree (RQT) 130 (FIG. 6A) and corresponding transform unit 150 (FIG. 6B), respectively, consistent with the techniques of this disclosure. RQT 130 includes nodes arranged in a hierarchical fashion. Each node may be a leaf node with no children, or may have four child nodes, hence the name “quadtree.” In the example of FIG. 6A, residual quadtree 130 includes root node 132. Root node 132 has four child nodes, including leaf nodes 134A and 134B (leaf nodes 134) and nodes 136A and 136B (nodes 136). Because nodes 136 are not leaf nodes, nodes 136 each include four child nodes. That is, in the example shown in FIG. 6A, node 136A has four child leaf nodes 138A-138D, while node 136B has three leaf nodes 140A-140C (leaf nodes 140) and node 142. In addition, node 142 has four leaf nodes 144A-144D (leaf nodes 144).

RQT 130 may include data describing characteristics of a corresponding transform unit (TU), such as TU 150 in this example. For example, RQT 130, by its structure, may describe splitting of TU 150 of FIG. 6B into sub-TUs. Assume that TU 150 has a size of 2N×2N. In this example, TU 150 has four sub-TUs, with two sub-TUs 152A and 152B (sub-TUs 152) of a size N×N. The remaining two sub-TUs of TU 150 are further split into smaller sub-CUs. That is, in the example shown in FIG. 6B, one of the sub-TUs of TU 150 is split into sub-TUs 154A-154D of size N/2×N/2, while the other sub-TU of TU 150 is split into sub-TUs 156A-156C (sub-TUs 156) of size N/2×N/2 and a further divided sub-TU, identified as sub-TUs 158A-1588D (sub-TUs 158) of a size N/4×N/4.

In the example shown in FIGS. 6A and 6B, the structure of RQT 130 corresponds to the splitting of TU 150. That is, root node 132 corresponds to TU 150 and leaf nodes 134 correspond to sub-TUs 152. Moreover, leaf nodes 138 (which is a child node of node 136A, which typically means that node 136A includes a pointer referencing leaf node 138) correspond to sub-TUs 154, leaf nodes 140 (e.g., belonging to node 136B) correspond to sub-TUs 156, and leaf nodes 144 (e.g., belonging to node 142) correspond to sub-TUs 158.

Data for nodes of RQT 130 may describe whether the TU corresponding to the node is split. If the TU is split, four additional nodes may be present in RQT 130. In some examples, a node of a quadtree may be defined by a process represented by the following pseudocode:

```
quadtree_node {
  boolean split_flag(1);
  // signaling data
  if (split_flag) {
    quadtree_node child1;
    quadtree_node child2;
    quadtree_node child3;
    quadtree_node child4;
  }
}
```

The split_flag value may be a one-bit value representative of whether the TU corresponding to the current node is split. If the TU is not split, the split_flag value may be ‘0’, while if the TU is split, the split_flag value may be ‘1’. With respect to the example of residual quadtree 130, an array of split_flag values may be 10011000001000000, which define the splitting structure from root node 132 down to the smallest leaf node (144A-144D).

A video coder, such as video encoder 20 and/or video decoder 30, typically applies transforms to both the luma and chroma samples at the same RQT depth, and does not consider PU type when determining transform partitioning limitations. As noted above, RQT depth generally relates to the number of times a TU has been split (e.g., RQT depth one corresponds to one division of the TU, as shown in FIG. 6B).

The techniques of this disclosure include applying different transform partitioning limitations based on a characteristic of the video data being coded. For example, according to aspects of this disclosure, the video coder may allow a TU to be partitioned to different depths, e.g., different depths of an RQT such as RQT 130 shown in FIG. 6A, when applying transforms based on a characteristic of the video data being coded. While certain aspects of FIGS. 6A and 6B are described below as being carried out by video encoder 20 (FIGS. 1 and 2), it should be understood that the techniques may also be carried out by another video coder, such as video decoder 30 (FIGS. 1 and 3). For example, video decoder 30 may determine and apply inverse transforms to coded video data according to the aspects of this disclosure.

In an example for purposes of explanation, TU 150 (corresponding to root node 132) may be a 64×64 TU (e.g., 64×64 luma samples and 32×32 chroma samples, assuming luma is sampled at twice the rate of chroma according to a 4:2:0 chroma format). Video encoder 20 may generally apply transforms to TUs of leaf nodes, such as leaf nodes 134, 138, 140, and 144. That is, video encoder 20 may apply transforms to residual data at RQT depth one for leaf nodes 134, at RQT depth two for leaf nodes 138 and 140, and RQT depth three for leaf nodes 144. Thus, in this example, video encoder 20 may apply a 32×32 transform to luma samples and a 16×16 transform to chroma samples of sub-TUs 152, a 16×16 transform to luma samples and an 8×8 transform to chroma samples of sub-TUs 154 and 156, and an 8×8 transform to luma samples and a 4×4 transform to chroma samples of sub-TUs 158.

According to aspects of this disclosure, video encoder 20 may limit the number of times that a TU may be divided based on a characteristic of the video data being coded. For example, assume that video encoder 20 allows TU 150 to be partitioned three times (e.g., RQT depth of three, resulting in sub-TUs 158) when applying transforms to luma samples. According to aspects of this disclosure, video encoder 20 may set an alternative maximum RQT depth for chroma samples. That is, video encoder 20 may set a maximum RQT depth of two for chroma samples. Accordingly, video encoder 20 may only partition TU 150 two times (resulting in sub-TUs 154 and 156) when applying transforms to chroma samples.

Video encoder 20 may also establish a transform partitioning limitation based on a PU type being used to predict the video data. For example, according to aspects of this disclosure, video encoder 20 may implement different RQT depths for different PU types. In an example, video encoder 20 may indicate the transform partitioning limitations using syntax elements in an encoded bitstream. For example, video encoder 20 may set a max_RQT_level_{—}2N×2N syntax element, a max_RQT_level_{—}2N×N syntax element, a max_RQT_level N×2N syntax element, and the like to specify the maximum RQT depths for PU types 2N×2N, 2N×N, N×2N, and the like. Such an approach may also be used for PU types associated with intra-coding (as described above with respect to FIG. 5).

In another example, video encoder 20 may signal the transform partitioning limitations differently. For example, video encoder 20 may code a max_RQT_level_base syntax element, which indentifies a baseline maximum RQT depth that is applied if no other signaling is received. In instances in which video encoder 20 deviates from the baseline (e.g., partitions a TU further than the baseline RQT depth), video encoder 20 may provide an offset syntax element to indicate the difference between the baseline and the RQT depth used. For example, video encoder 20 may establish an offset for 2N×2N type PUs using a max_RQT_level_offset_{—}2N×2N syntax element. In this example, the actual maximum RQT level for a 2N×2N PU can be derived by summing the max_RQT_level_base value and the max_RQT_level_offset_{—}2N×2N value.

In another example, while video encoder 20 may signal the offset, in other examples, offsets for different PU types may be predefined. For example, video encoder 20 may provide a baseline RQT depth (max_RQT_level_base) as a syntax element in the bitstream. In addition, each PU type may have a predetermined, default offset (which is known to both video encoder 20 and video decoder 30). Accordingly, in this example, there is no need to signal offsets for different PU types to derive a particular maximum RQT depth.

While each PU type may have a different transform partitioning limitation, in other examples, PU types may be grouped such that certain PU types share the same transform partitioning limitation. For example, according to aspects of this disclosure, several different PU types can be grouped together and share the same maximum RQT depth. In this example, video encoder 20 may signal the maximum RQT depth for different groups of PUs. In one example for purposes of illustration, video encoder 20 may set a first maximum RQT depth syntax element for 2N×2N PUs and a second, different maximum RQT depth for PU types 2N×N, N×2N, and the AMP types (shown in the example of FIG. 5).

The examples above are described with respect to maximum RQT depths. In other examples, other transform partitioning limitations may be implemented by video encoder 20 and video decoder 30. For example, similar techniques as those described above may be implemented to establish specific RQT depths (e.g., versus maximum allowed RQT depths). That is, video encoder 20 may implement RQT depths to which TUs must be partitioned. In this example, video encoder 20 may establish different RQT depths based on colorspace, PU type, or other characteristics.

In such examples, video encoder 20 may indicate the RQT depths in a similar manner as described above, using syntax elements in an encoded bitstream. For example, video encoder 20 may set an RQT_level_{—}2N×2N syntax element, an RQT_level_{—}2N×N syntax element, an RQT_level N×2N syntax element, and the like to specify the RQT depths for PU types 2N×2N, 2N×N, N×2N, and the like. In other examples, video encoder 20 may implement the baseline or grouping approaches described above.

Video decoder 30 may implement transform partitioning limitations in a similar way as those described with respect to video encoder 20 above. That is, video decoder 30 may determine transform partitioning limitations based on a characteristic of the video data being coded. In instances in which one or more maximum RQT depth syntax elements are provided in an encoded bitstream, video decoder 30 may parse and decode such elements when determining transform partitioning limitations.

While certain aspects of FIGS. 6A and 6B are described with respect to video encoder 20 and video decoder 30 for purposes of explanation, it should be understood that other video coding units, such as other processors, processing units, hardware-based coding units including encoder/decoders (CODECs), and the like, may also be configured to perform the examples and techniques described with respect to FIGS. 6A and 6B.

Moreover, while aspects of FIG. 6A and 6B (and elsewhere in this disclosure) are described with respect to colorspace and PU type, it should be understood that the techniques of this disclosure are not limited in this way. That is, the techniques of this disclosure are more generally applicable to adaptation of an RQT depth at which transforms are applied to residual video data. For example, a video coder (such as video encoder 20 and/or video decoder 30) may implement the techniques of this disclosure to dynamically adapt the manner in which transforms are applied based on colorspace, PU type, block size, prediction direction, prediction type (e.g., intra-prediction or inter-prediction), motion vector amplitude, reference frame index, and the like. Moreover, while syntax elements may be used to signal different RQT depths (or different maximum allowable RQT depths), in other examples, a video encoder and a video decoder may be preconfigured to apply the same techniques, thereby negating the need to signal such syntax elements.

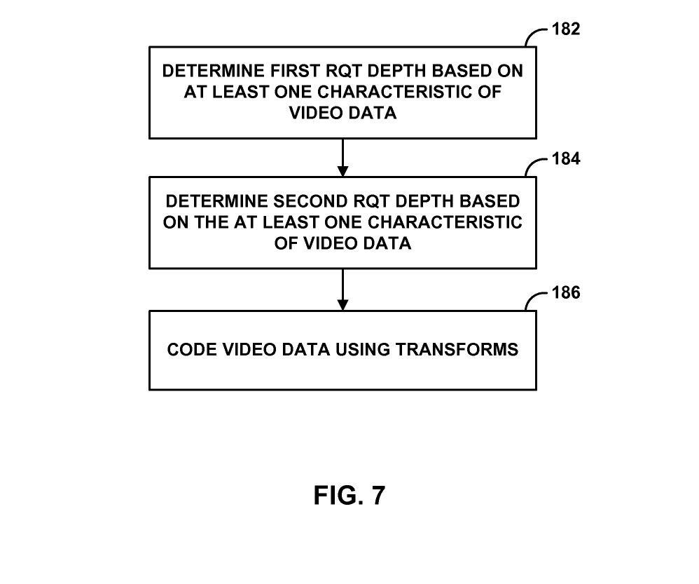

FIG. 7 is a flow diagram illustrating a technique of coding video data consistent with this disclosure. The example shown in FIG. 7 is generally described as being performed by a video coder. It should be understood that, in some examples, the method of FIG. 7 may be carried out by video encoder 20 (FIGS. 1 and 2) or video decoder 30 (FIGS. 1 and 3), described above. In other examples, the method of FIG. 7 may be performed by a variety of other processors, processing units, hardware-based coding units such as encoder/decoders (CODECs), and the like.

According to aspects of this disclosure, the video coder may determine a first RQT depth at which to apply one or more transforms to video data based on at least one characteristic of the video data (182). In some instances, the characteristic may include a colorspace or a PU type. In other instances the characteristic may include a block size, prediction direction, prediction type (e.g., intra-prediction or inter-prediction), motion vector amplitude, reference frame index, and the like. In any case, as noted above, the RQT depth may indicate the number of times a TU may be divided according to an RQT structure when applying transforms or inverse transforms to video data.

The video coder also determines a second RQT depth at which to apply one or more second transforms based on the at least one characteristic of the video data (184). For example, in instances in which PU type is used to determine the first RQT depth, the video coder may also determine the second RQT depth based on the PU type. The video coder may then code the video data using the first transforms and second transforms. That is, in instances in which the video coder is a video encoder (such as video encoder 20), the video encoder may apply the transforms to generate transform coefficients. The video encoder may also provide an indication of the RQT depths or an RQT baseline depth.

In instances in which the video coder is a video decoder, (such as video decoder 30), the video decoder may apply inverse transforms to generate residual values from transform coefficients. In this way, “transforms” may generally describe forward transforms (for transforming residual values into transform coefficients), as well as inverse transforms (for transforming transform coefficients into residual values). The video decoder may, in some instances, also decode an indication of the RQT depths or an indication of an RQT baseline depth.

It should also be understood that the steps shown and described with respect to FIG. 7 are provided as merely one example. That is, the steps of the method of FIG. 7 need not necessarily be performed in the order shown in FIG. 7, and fewer, additional, or alternative steps may be performed.

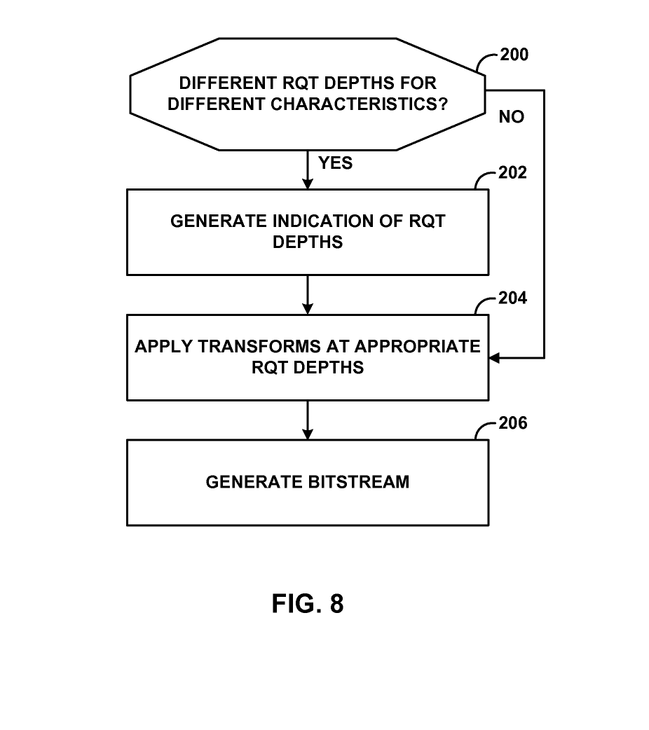

FIG. 8 is a flow diagram illustrating a technique of encoding video data consistent with this disclosure. Although generally described as performed by components of video encoder 20 (FIGS. 1 and 2) for purposes of explanation, it should be understood that other video coding units, processors, processing units, hardware-based coding units such as encoder/decoders (CODECs), and the like, may also be configured to perform the method of FIG. 8.

According to the example method shown in FIG. 8, video encoder 20 may determine whether to apply more than one transform partitioning limitation (e.g., RQT depth, maximum allowable RQT depth, or the like) for different characteristics of video data (200). Video encoder 20 may make the determination, for example, based on a rate-distortion or other coding analysis, or may be preconfigured to apply more than one transform partitioning limitation. If video encoder 20 does apply different RQT depths (or maximum allowable RQT depths) for video data having different characteristics (the “YES” branch of step 200), video encoder 20 may generate an indication of the RQT depths (202). For example, as noted above, video encoder 20 may encode one or more syntax elements to indicate the different RQT depths being implemented. In examples in which an RQT depth (or maximum allowable RQT depth) is determined according to PU type, video encoder 20 may encode a syntax element for each PU type. In other examples, video encoder 20 may encode syntax elements for groups of PU types sharing the same RQT depths. In still other examples, video encoder 20 may encode a baseline RQT depth syntax element, which may be used by a video decoder to calculate the appropriate RQT depth, as described above.

Video encoder 20 also applies transforms at the appropriate RQT depths (204). By applying the transforms, the video encoder 20 may transform residual video data to transform coefficients. Video encoder 20 then generates a bitstream containing the transform coefficients, as well as one or more indications of transform partitioning limitations, e.g., RQT depts., as described above (206).

It should also be understood that the steps shown and described with respect to FIG. 8 are provided as merely one example. That is, the steps of the method of FIG. 8 need not necessarily be performed in the order shown in FIG. 8, and fewer, additional, or alternative steps may be performed.

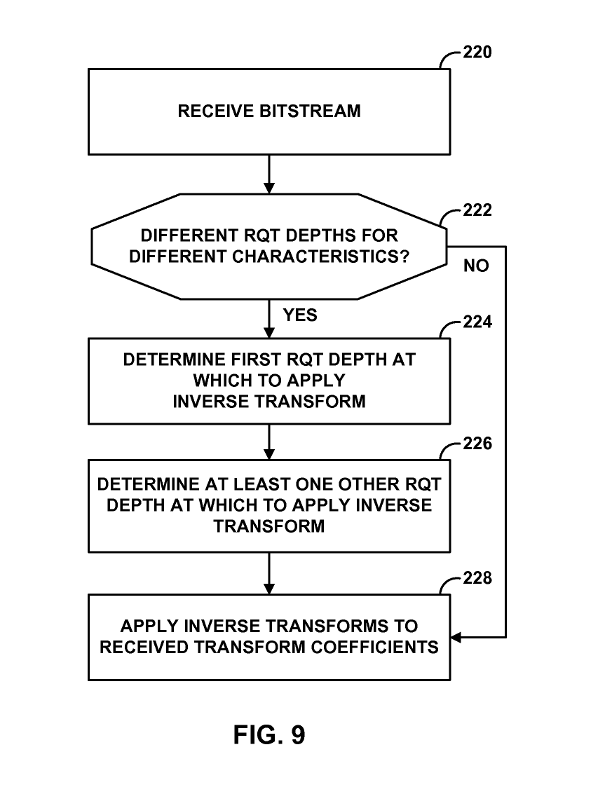

FIG. 9 is a flow diagram illustrating a technique of decoding video data consistent with this disclosure. Although generally described as performed by components of video decoder 30 (FIGS. 1 and 3) for purposes of explanation, it should be understood that other video coding units, processors, processing units, hardware-based coding units such as encoder/decoders (CODECs), and the like, may also be configured to perform the method of FIG. 9.

Video decoder 30 receives an encoded bitstream (220). Video decoder 30 then determines whether to apply different transform partitioning limitations (e.g., RQT depths, maximum allowable RQT depths, or the like) to video data based on one or more characteristics of the video data (222). In some instances, video decoder 30 may make such a determination based on an indication included in the received bitstream. For example, as described above with respect to FIG. 8, video decoder 30 may make such a determination based one or more syntax elements included in the received bitstream. In other examples, video decoder 30 may be preconfigured to apply different transform partitioning limitations by default, without such signaling.

If different RQT depths (or maximum allowable RQT depths) are established (the “YES” branch of step 222), video decoder 30 may determine a first RQT depth at which to apply one or more inverse transforms to transform coefficients (224). In addition, video decoder 30 may determine at least one other RQT depth at which to apply one or more inverse transforms to transform coefficients (226). In some examples, video decoder 30 may make such determinations based on a characteristic of the video data being decoded. That is, as noted above, the characteristic may include a colorspace, PU type, block size, prediction direction, prediction type (e.g., intra-prediction or inter-prediction), motion vector amplitude, reference frame index, and the like. As described above with respect to FIG. 8, video decoder 30 may also receive one or more indications regarding the RQT depths.

After determining the appropriate RQT depths at which to apply inverse transforms, video decoder 30 may apply inverse transforms to received transform coefficients to generate residual video data (228). It should also be understood that the steps shown and described with respect to FIG. 9 are provided as merely one example. That is, the steps of the method of FIG. 9 need not necessarily be performed in the order shown in FIG. 9, and fewer, additional, or alternative steps may be performed.

It should also be understood that, depending on the example, certain acts or events of any of the methods described herein can be performed in a different sequence, may be added, merged, or left out all together (e.g., not all described acts or events are necessary for the practice of the method). Moreover, in certain examples, acts or events may be performed concurrently, e.g., through multi-threaded processing, interrupt processing, or multiple processors, rather than sequentially. In addition, while certain aspects of this disclosure are described as being performed by a single module or unit for purposes of clarity, it should be understood that the techniques of this disclosure may be performed by a combination of units or modules associated with a video coder.

It should also be understood that, while certain aspects of this disclosure have been described with respect to the emerging HEVC standard, e.g., with respect to CUs, PUs, and TUs, the techniques of this disclosure are not limited in this way. That is, the techniques of this disclosure broadly apply to applying transforms to luma and chroma samples associated with a block of video data, and are not limited to any specific coding standard.

In one or more examples, the functions described in this disclosure may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol.

In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the disclosure have been described. These and other aspects are within the scope of the following claims.

What is claimed is:

1. A method of coding video data, the method comprising:
determining a first residual quadtree (RQT) depth at which to apply one or more first transforms to residual video data based on at least one characteristic of the residual of video data;
determining a second RQT depth at which to apply one or more second transforms to the residual video data based on the at least one characteristic; and
coding the residual video data using the one or more first transforms and the one or more second transforms.

2. The method of claim 1, wherein determining the first RQT depth comprises determining a first maximum allowable RQT, and wherein determining the second RQT depth comprises determining a second maximum allowable RQT depth.

3. The method of claim 1,
wherein the at least one characteristic comprises a colorspace;
wherein determining the first RQT depth comprises determining a first maximum allowable RQT for applying one or more transforms to luma values of the video data; and
wherein determining the second RQT depth comprises determining a second maximum allowable RQT value for applying one or more transforms to chroma values of the video data.

4. The method of claim 1,
wherein the at least one characteristic comprises a prediction unit type of a prediction unit associated with the residual video data;
wherein determining the first RQT depth comprises determining a first maximum allowable RQT based on a first PU type; and
wherein determining the second RQT depth comprises determining a second maximum allowable RQT based on a second PU type.

5. The method of claim 1,
wherein the at least one characteristic comprises a prediction unit type of a prediction unit associated with the residual video data;
wherein determining the first RQT depth comprises determining a first maximum allowable RQT based on a first group of PU types; and
wherein determining the second RQT depth comprises determining a second maximum allowable RQT based on a second group of PU types.

6. The method of claim 5, wherein the prediction unit type comprises one of a partitioning mode, a prediction unit size, and a prediction mode.

7. The method of claim 1, wherein coding the residual video data comprises encoding the residual video data, and wherein encoding comprises:
applying the one or more first transforms to generate first transform coefficients; and
applying the one or more second transforms to generate second transform coefficients.

8. The method of claim 7, wherein encoding the residual video data further comprises generating a bitstream comprising an indication of the first RQT depth and an indication of the second RQT depth.

9. The method of claim 7, wherein encoding the residual video data further comprises generating a bitstream comprising an indication of a baseline value for determining the first RQT depth and the second RQT depth.

10. The method of claim 1, wherein coding the residual video data comprises decoding the residual video data, and wherein decoding comprises:
applying the one or more first transforms to generate first residual samples; and
applying the one or more second transform to generate second residual samples.

11. The method of claim 10, wherein decoding further comprises decoding a bitstream to determine the first RQT depth and an indication of the second RQT depth.

12. The method of claim 11, wherein determining the first RQT depth and the second RQT depth comprises decoding one of a sequence parameter set (SPS), a picture parameter set (PPS), and a slice header containing an indication of the first RQT depth and the second RQT depth.

13. The method of claim 10, wherein decoding further comprises decoding a bitstream to determine a baseline value for determining the first RQT depth and the second RQT depth.

14. An apparatus for coding video data, the apparatus comprising one or more processors configured to:
determine a first residual quadtree (RQT) depth at which to apply one or more first transforms to residual video data based on at least one characteristic of the residual of video data;
determine a second RQT depth at which to apply one or more second transforms to the residual video data based on the at least one characteristic; and
code the residual video data using the one or more first transforms and the one or more second transforms.

15. The apparatus of claim 14, wherein to determine the first RQT depth, the one or more processors are configured to determine a first maximum allowable RQT, and wherein to determine the second RQT depth, the one or more processors are configured to determine a second maximum allowable RQT depth.

16. The apparatus of claim 14,
wherein the at least one characteristic comprises a colorspace;
wherein to determine the first RQT depth, the one or more processors are configured to determine a first maximum allowable RQT for applying one or more transforms to luma values of the video data; and
wherein to determine the second RQT depth, the one or more processors are configured to determine a second maximum allowable RQT value for applying one or more transforms to chroma values of the video data.

17. The apparatus of claim 14,
wherein the at least one characteristic comprises a prediction unit type of a prediction unit associated with the residual video data;
wherein to determine the first RQT depth, the one or more processors are configured to determine a first maximum allowable RQT based on a first PU type; and
wherein to determine the second RQT depth, the one or more processors are configured to determine a second maximum allowable RQT based on a second PU type.

18. The apparatus of claim 14,
wherein the at least one characteristic comprises a prediction unit type of a prediction unit associated with the residual video data;
wherein to determine the first RQT depth, the one or more processors are configured to determine a first maximum allowable RQT based on a first group of PU types; and
wherein to determining the second RQT depth, the one or more processors are configured to determine a second maximum allowable RQT based on a second group of PU types.

19. The apparatus of claim 18, wherein the prediction unit type comprises one of a partitioning mode, a prediction unit size, and a prediction mode.

20. The apparatus of claim 14, wherein to code the residual video data, the one or more processors are configured to encode the residual video data, and wherein to encode, the one or more processors are configured to:
apply the one or more first transforms to generate first transform coefficients; and
apply the one or more second transforms to generate second transform coefficients.

21. The apparatus of claim 20, wherein to encode the residual video data, the one or more processors are further configured to generate a bitstream comprising an indication of the first RQT depth and an indication of the second RQT depth.

22. The apparatus of claim 20, wherein to encode the residual video data, the one or more processors are further configured to generate a bitstream comprising an indication of a baseline value for determining the first RQT depth and the second RQT depth.

23. The apparatus of claim 14, wherein to code the residual video data, the one or more processors are configured to decode the residual video data, and wherein to decode, the one or more processors are configured to:
apply the one or more first transforms to generate first residual samples; and
apply the one or more second transform to generate second residual samples.

24. The apparatus of claim 23, wherein to decode, the one or more processors are further configured to decode a bitstream to determine the first RQT depth and an indication of the second RQT depth.

25. The apparatus of claim 24, wherein to determine the first RQT depth and the second RQT depth, the one or more processors are configured to decode one of a sequence parameter set (SPS), a picture parameter set (PPS), and a slice header containing an indication of the first RQT depth and the second RQT depth.

26. The apparatus of claim 23, wherein to decode, the one or more processors are further configured to decode a bitstream to determine a baseline value for determining the first RQT depth and the second RQT depth.

27. An apparatus for coding video data, the apparatus comprising:
means for determining a first residual quadtree (RQT) depth at which to apply one or more first transforms to residual video data based on at least one characteristic of the residual of video data;
means for determining a second RQT depth at which to apply one or more second transforms to the residual video data based on the at least one characteristic; and
means for coding the residual video data using the one or more first transforms and the one or more second transforms.

28. The apparatus of claim 27, wherein means for determining the first RQT depth comprises means for determining a first maximum allowable RQT, and wherein means for determining the second RQT depth comprises means for determining a second maximum allowable RQT depth.

29. The apparatus of claim 27,
wherein the at least one characteristic comprises a colorspace;
wherein means for determining the first RQT depth comprises means for determining a first maximum allowable RQT for applying one or more transforms to luma values of the video data; and
wherein means for determining the second RQT depth comprises means for determining a second maximum allowable RQT value for applying one or more transforms to chroma values of the video data.

30. The apparatus of claim 27,
wherein the at least one characteristic comprises a prediction unit type of a prediction unit associated with the residual video data;
wherein means for determining the first RQT depth comprises means for determining a first maximum allowable RQT based on a first PU type; and
wherein means for determining the second RQT depth comprises means for determining a second maximum allowable RQT based on a second PU type.

31. The apparatus of claim 27,
wherein the at least one characteristic comprises a prediction unit type of a prediction unit associated with the residual video data;
wherein means for determining the first RQT depth comprises means for determining a first maximum allowable RQT based on a first group of PU types; and
wherein means for determining the second RQT depth comprises means for determining a second maximum allowable RQT based on a second group of PU types.

32. The apparatus of claim 31, wherein the prediction unit type comprises one of a partitioning mode, a prediction unit size, and a prediction mode.

33. A non-transitory computer-readable medium storing instructions that, when executed, cause one or more processors to:
determine a first residual quadtree (RQT) depth at which to apply one or more first transforms to residual video data based on at least one characteristic of the residual of video data;
determine a second RQT depth at which to apply one or more second transforms to the residual video data based on the at least one characteristic; and
code the residual video data using the one or more first transforms and the one or more second transforms.

34. The computer-readable medium of claim 33, wherein to determine the first RQT depth, the instructions cause the one or more processors to determine a first maximum allowable RQT, and wherein to determine the second RQT depth, the instructions cause the one or more processors to determine a second maximum allowable RQT depth.

35. The computer-readable medium of claim 33,
wherein the at least one characteristic comprises a colorspace;
wherein to determine the first RQT depth, the instructions cause the one or more processors to determine a first maximum allowable RQT for applying one or more transforms to luma values of the video data; and
wherein to determine the second RQT depth, the instructions cause the one or more processors to determine a second maximum allowable RQT value for applying one or more transforms to chroma values of the video data.

36. The computer-readable medium of claim 33,
wherein the at least one characteristic comprises a prediction unit type of a prediction unit associated with the residual video data;
wherein to determine the first RQT depth, the instructions cause the one or more processors to determine a first maximum allowable RQT based on a first PU type; and
wherein to determine the second RQT depth, the instructions cause the one or more processors to determine a second maximum allowable RQT based on a second PU type.

37. The computer-readable medium of claim 33,
wherein the at least one characteristic comprises a prediction unit type of a prediction unit associated with the residual video data;
wherein to determine the first RQT depth, the instructions cause the one or more processors to determine a first maximum allowable RQT based on a first group of PU types; and
wherein to determining the second RQT depth, the instructions cause the one or more processors to determine a second maximum allowable RQT based on a second group of PU types.

38. The computer-readable medium of claim 37, wherein the prediction unit type comprises one of a partitioning mode, a prediction unit size, and a prediction mode.
